(19) United States
(12) Patent Application Publication
(10) Pub. No.: US 2011/0184775 A1
(43) Pub. Date: Jul. 28, 2011

(54) Automated Routing Process

(75) Inventors: Mary A. Vasquez, Chicago, IL (US); Deborah J. Adams, Charlotte, NC (US)

(73) Assignee: Bank of America Corporation, Charlotte, NC (US)

(21) Appl. No.: 12/693,488

(22) Filed: Jan. 26, 2010

(51) Int. Cl. G06F 15/173; G06Q 10/00; G06Q 40/00

(52) U.S. Cl. 705/7.26; 709/238; 705/30

(57) ABSTRACT

A system and method of automatically routing cases for processing is presented. The system and method may include identifying cases for processing at multiple entities and associating a transfer indication with the cases. The transfer indication then provides an indication to bypass a first set of routing instructions and instead to forward the case for processing to the multiple entities indicated in a second set of routing instructions.

### BACKGROUND

Processing of financial transactions is prone to error due to the substantial volume of transactions conducted on a daily basis and the speed with which the transactions must be processed due to customer expectations and demand. Any delay in the processing of financial transactions, and/or errors identified in financial transactions, may be problematic. Although some automation of processing exists, the automation may be error prone and may result in delays occurring should a processed transaction not perform the processing steps to completion (e.g., the transaction gets “stuck” in the process). Accordingly, a system and method of automatically moving transactions that may be “stuck” through the process and/or to another entity for further processing would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, data associated with transactions and, in particular, transactions requiring an adjustment due to an error in processing the transaction, may be received from various sources. The data may, in some arrangements, be received at a transaction data processing system associated with a financial institution. The data may be processed and cases may be built and associated with transactions needing adjustments. The cases may include a first set of routing instructions for automatically processing the case. In some examples, the cases may include a transfer indication indicating that the case may be transferred between more than one entity for processing. Upon determining that the case includes a transfer indication, the first set of routing instructions may be bypassed and a second transfer set of instructions, may be implemented for processing the case. In some examples, the second transfer set of routing instructions may include sequential instructions indicating an order in which the case should be forwarded to the identified entities for processing.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example network environment for automatically processing transaction data according to one or more aspects described herein.

FIG. 3 illustrates an example user interface illustrating various routing instructions for cases according to one or more aspects described herein.

FIG. 4 illustrates one example method by which a financial institution may process transaction data and provide routing instructions for automatically processing the case according to one or more aspects described herein.

FIG. 5 illustrates one example method of automatically processing cases according to routing instructions according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

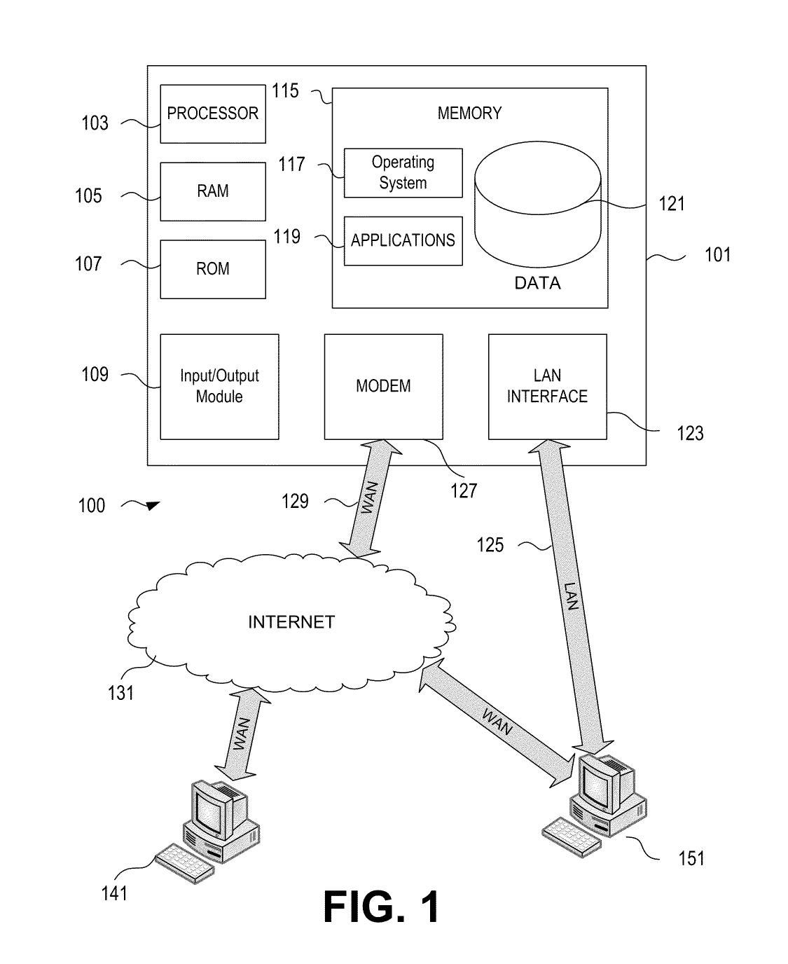

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The system, devices and networks of FIG. 1 may, in one or more arrangements, be used to provide transaction adjustment functionality. Transaction adjustments are used to resolve discrepancies between what is claimed as owed or paid and what is actually owed or paid. For example, a check adjustment may be needed where Bank A receives $100 from Bank B for a $1000 check deposited at Bank A. The error may result from a misread of the check or check image, amount entry error, check reference number entry error or the like. Accordingly, an adjustment must be applied to the check transaction to compensate Bank A for the difference, i.e., $900. A system may be used to streamline the research and resolution of transaction adjustment cases. The system may provide automated workflow procedures for the entry and building of transaction adjustment cases, organization of transaction adjustment cases, creation of user interfaces for data entry, editing and viewing of case information including check images, interfacing with legacy and third party applications and the like. For example, the system may receive data from a transaction data collection system and automatically populate fields to build a transaction case.

In some conventional arrangements, work flow processes (e.g., automated work flow processes) may have a stoppage point when, for instance, a case is transferred to another department for additional processing, etc. This stoppage decreases productivity as, in some examples, it may require a user to manually route the case to the proper department, individual, etc. An automated routing process, as described herein, would thereby increase productivity by reducing the need for a user to manually transfer or route cases.

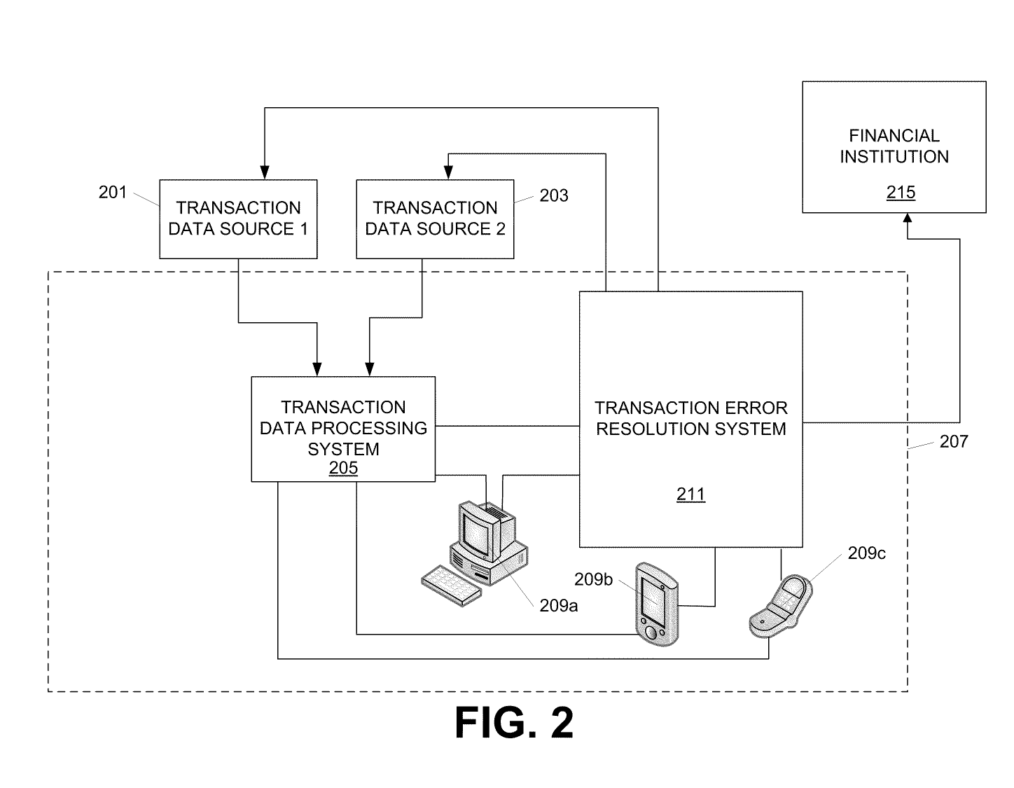

FIG. 2 illustrates one example network computing environment in which the automated routing process described herein may be implemented. The system may include transaction data received from various sources, such as sources 201 and 203. These sources may include external data sources such as the Federal Reserve, national clearinghouses such as SVPCO, any bank or other institution that handles the clearing of funds for checks, etc. and the like. The data may include various transactions that may require an adjustment or additional processing. In some examples, the data may be received at a transaction data processing system 205. The transaction data processing system 205 may receive the data, and in some cases, may build a case or other record to facilitate processing of the data (for instance, completing an adjustment, etc.). The case may, in some examples, include an assignment identifier which may indicate the department, individual, etc. to whom the case should be routed for processing. In some examples, the unique assignment identifier may include an indication that the case may be transferred between multiple departments, individuals, parties, etc. This transfer indication may aid in proper routing of the case because routing of the case may then be completed according to the one or more parties associated with that case, as will be discussed more fully below. The assignment identifier may be automatically assigned by the transaction data processing system 205 or may be manually entered, such as via input systems 209a-209c.

Once a case is established and the appropriate routing instructions (e.g., unique assignment identifier) have been provided, the case may be transferred to the transaction error resolution system 211, which may, in some examples, include the departments, individuals, parties, etc. to which the cases are to be routed for processing. In some arrangements, the transaction data processing system 205 and transaction error resolution system 211 may be contained within a financial institution, such as financial institution 207. Once the appropriate transaction processing is completed, data (such as a debit, credit, etc.) may be transmitted to another financial institution, such as financial institution 215, as needed.

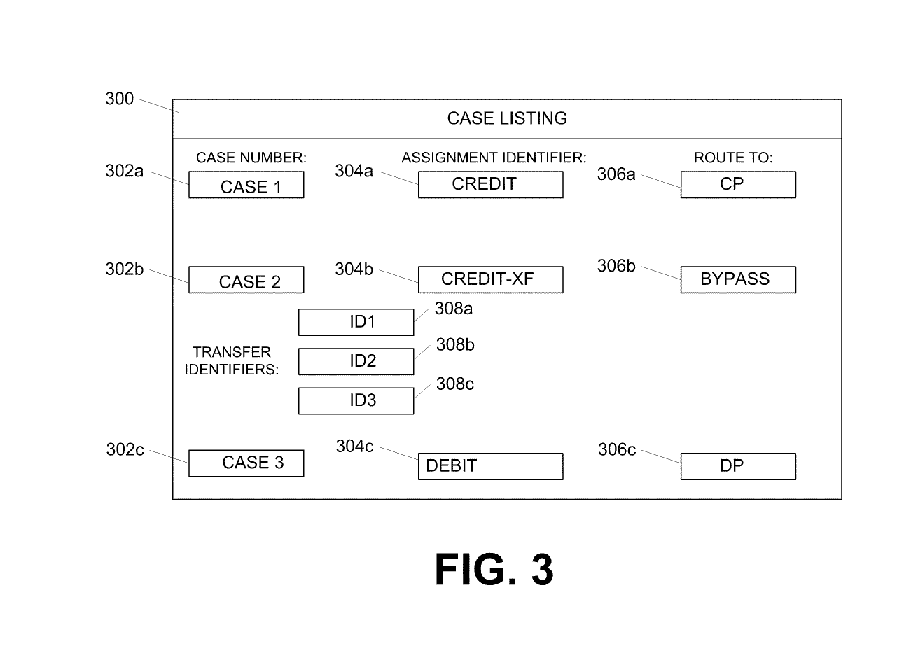

FIG. 3 illustrates one example user interface for use with the automated routing process described herein. The user interface 300 includes various cases, such as case 1 302a, case 2 302b, case 3 302c. The cases 302 may include transaction information, etc. as described above. The user interface 300 further includes an assignment identifier in fields 304a-304c. The unique assignment identifier may be used to route the case to the proper channels for processing. For instance, case 1 302a includes an assignment identifier of “credit” in field 304a. This indicates that the case is an adjustment including a credit and, in field 306a, should be routed to credit processing (CP). In some examples, this type of routing may forward the case to the credit processing department and a first available processor may handle the case. Additionally or alternatively, the routing in fields 306a-306c may be to a particular department, individual, etc. as desired. Accordingly, case 1 302a may be automatically moved through the transaction processing system according to the routing instructions provided.

Alternatively, case 2 302b includes an assignment identifier “credit-XF” in field 304b. This identifier may indicate that a transfer of the case 302b may be required in order to complete processing. Accordingly, the “route to” field 306b may indicate a bypass. That is, the typical rules for routing the case may be bypassed and, instead of routing case 2 304b to “credit processing” as with case 1 302a, alternate routing instructions may be provided in order to ensure that case 2 302b continues through the automated process without requiring manual routing, as with some conventional systems. Accordingly, alternate routing instructions are provided in fields 308a-308c. Although three different entities to which the case should be routed are provided, more or fewer entities may be used without departing from the invention. In some examples, the case may be routed sequentially, i.e., first the case will be routed to the entity in field 308a, followed by the entity in 308b, followed by the entity in 308c. In still other examples, a person to whom the case has been routed may also amend the routing instructions to provide transfer routing for the case, as desired.

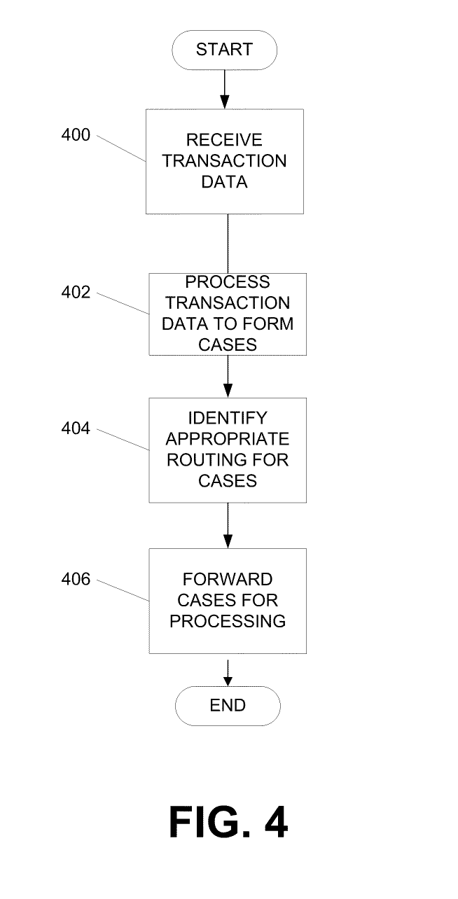

FIG. 4 is a flow chart illustrating one example method of receiving and processing transaction data according to the automated routing process described herein. In step 400 transaction data is received from various sources, as described above. The transaction data may be received at a transaction data processing system (e.g., system 205 in FIG. 2). In step 402, the received data may be processed to build one or more cases. In some examples, each case may be associated with a transaction, such as transactions performed at financial institutions, that may require an adjustment due to an error in processing the transaction. The cases may further include information associated with a user, account number, routing number or other identifying information for other financial institutions associated with the transaction, etc.

In step 404 appropriate routing for processing the cases is determined. In some examples, the type of adjustment or transaction may be one factor in determining the proper routing for the case. In some arrangements, the case may be transferred to more than one entity for processing. In these arrangements, the multiple entities may be noted for routing the case for processing. In some examples, an assignment identifier or other routing instruction is associated with the case. In step 406 the case is forwarded, for instance, to a system or entity, for additional processing.

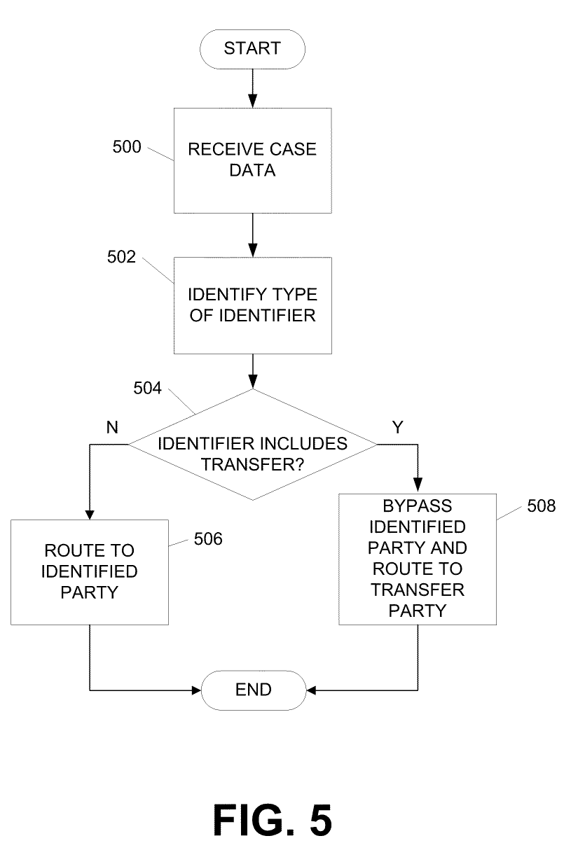

FIG. 5 illustrates one example method of routing cases for processing according to at least some aspects of the automated routing process described herein. In step 500 case data is received, for instance, from the transaction data processing system. In step 502 an identifier or other indication of the type of adjustment, processing, etc. is identified. In step 504 a determination is made as to whether the identifier includes a transfer indication. In some examples, the transfer indication may be an electronic marking and/or flag within the case. A transfer indication may indicate that processing the case may include processing by multiple entities and the case may be transferred between those entities for processing. If there is no indication of a transfer, the case may be routed to an entity indicated in a first set of routing instructions in step 506. If a transfer indication is identified, the first set of routing instructions may be bypassed and a second set of transfer routing instructions may be implemented in step 508. The second set of routing instructions may include multiple entities to which the case will be routed for processing and the case may be automatically transferred to those entities for further processing.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method comprising:
receiving transaction data at a transaction data processing system;
processing the received data to build a case;
providing first routing instructions for processing the case;
determining if the first routing instructions include a transfer instruction; and
responsive to determining that the first routing instructions include a transfer instruction, bypassing the first routing instructions and processing the case according to second routing instructions.

2. The method of claim 1, further including responsive to determining that the first routing instructions do not include a transfer instruction, processing the case according to the first routing instructions.

3. The method of claim 1, wherein the first routing instructions include an assignment identifier.

4. The method of claim 3, wherein the first routing instructions further include identification of an entity for processing the case.

5. The method of claim 4, wherein the entity is at least one of a department and individual.

6. The method of claim 1, wherein the second routing instructions include at least two entities to which the case is to be transferred for processing.

7. The method of claim 6, wherein the at least two entities are at least one of a department and an individual.

8. The method of claim 1, wherein the second routing instructions include a sequential order in which the case is to be transferred to the at least two entities.

9. The method of claim 1, wherein the transaction data processing system is associated with a financial institution.

10. The method of claim 9, wherein the case includes information associated with an adjustment to a transaction performed at the financial institution.

11. An apparatus comprising:
a processor; and
memory operatively coupled to the processor and storing computer readable instructions that, when executed, cause the apparatus to:
receive transaction data at a transaction data processing system;
process the received data to build a case;
provide first routing instructions for processing the case;
determine if the first routing instructions include a transfer instruction; and
responsive to determining that the first routing instructions include a transfer instruction, bypass the first routing instructions and processing the case according to second routing instructions.

12. The apparatus of claim 11, further including responsive to determining that the first routing instructions do not include a transfer instruction, process the case according to the first routing instructions.

13. The apparatus of claim 11, wherein the first routing instructions include an assignment identifier.

14. The apparatus of claim 13, wherein the first routing instructions further include identification of an entity for processing the case.

15. The apparatus of claim 11, wherein the second routing instructions include at least two entities to which the case is to be transferred for processing.

16. The apparatus of claim 11, wherein the transaction data processing system is associated with a financial institution.

17. The apparatus of claim 16, wherein the case includes information associated with an adjustment to a transaction performed at the financial institution.

18. One or more computer readable media storing computer readable instructions that, when executed, cause an apparatus to:
receive transaction data at a transaction data processing system;
process the received data to build a case;
provide first routing instructions for processing the case;
determine if the first routing instructions include a transfer instruction; and
responsive to determining that the first routing instructions include a transfer instruction, bypass the first routing instructions and processing the case according to second routing instructions.

19. The one or more computer readable media of claim 18, further including responsive to determining that the first routing instructions do not include a transfer instruction, process the case according to the first routing instructions.

20. The one or more computer readable media of claim 18, wherein the first routing instructions include an assignment identifier.

21. The one or more computer readable media of claim 20, wherein the first routing instructions further include an entity for processing the case.

22. The one or more computer readable media of claim 18, wherein the second routing instructions include at least two entities to which the case is transferred for processing.

23. The one or more computer readable media of claim 18, wherein the transaction data processing system is associated with a financial institution.

24. The one or more computer readable media of claim 23, wherein the case includes information associated with an adjustment to a transaction performed at the financial institution.
